(19) United States
(12) Patent Application Publication
(10) Pub. No.: US 2010/0293184 A1
(43) Pub. Date: Nov. 18, 2010

(54) IDENTIFICATION OF RELATED BID PHRASES AND CATEGORIES USING CO-BIDDING INFORMATION

(75) Inventors: Vanja Josifovski, Los Gatos, CA (US); Andrei Broder, Menlo Park, CA (US); Patrick Pantel, Santa Clara, CA (US); Ana-Maria Popescu, Mountain View, CA (US); Evgeniy Gabrilovich, Sunnyvale, CA (US); William Swei Chang, Los Angeles, CA (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(73) Assignee: YAHOO! INC., Sunnyvale, CA (US)

(21) Appl. No.: 12/465,077

(22) Filed: May 13, 2009

(51) Int. Cl. G06F 17/30

(52) U.S. Cl. 707/769; 707/708

(57) ABSTRACT

The present invention provides a method and system for determining related bid terms. The method and system includes accessing a term database to determine a plurality of term pairs, the term pairs being paired terms bidded together in a term bidding operating environment. In the method and system, for each of the plurality of term pairs, the method and system includes determining similarity values for each of the term pairs. The method and system further includes generating a similarity matrix using the determined similarity values. And, the method and system includes generating an output result based on a co-bidded relationship between at least one of the terms and advertising information.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The present invention relates generally to online advertising technology and more specifically to mining term bidding information for identifying relationships for advertising selection.

In existing web-based advertising systems, there are various techniques allowing for parties to bid on textual terms. Various parties seeking the right to associate advertisement when a term is used, such as in a search operation or content display typically perform the bidding. In the example of a search results page, the selected advertisements are determined by various factors, including which party or parties bidded the highest amount and hence have the right for the placement of an ad.

There are complex systems that allow for various types of online term bidding. In addition to bidding on a single term, there is also bidding for multiple terms, for example a party may bid for not only the term “MP3” but also bid for the term “iPod”®. These co-bidded terms allow for a greater degree in flexibility search result determination and advertisement placement, especially in view of the long tail distribution of search terms.

The relationship of co-bidded terms allows for not only improving the web operations themselves, but also allows for increased functionality for parties that associate information with various terms. One example may be someone conducting an online search where the person uses a product model identifier instead of listing the product itself, e.g. the user types “nc4200” into the search bar. It can be extremely beneficial on many different levels to be able to recognize that this might refer to a particular company's laptop computer. Whereas existing systems would base the bidding on the more common term of “computer” or “laptop,” for example, the long tail distribution of search terms and user queries provides a large degree of terms not being properly serviced for associated content.

The long tail refers to the distribution of term usage, where the vast amount of information being distributed on the Internet and uses of terminology provides a long tail distribution where a small number of keywords or terms have a significantly high distribution of usage and the remaining keywords or terms have a significantly smaller distribution.

The co-bidded terms are typically stored in a database. There are several known existing techniques for determining bid term suggestions, and hence relationships between bid terms, using the co-bidded terms stored in the database. A first technique relies on search engine results, such as determining an equivalent traffic volume for an advertiser bidding on a numerous low volume terms compared with one or several high volume terms. A second technique relies on search engine logs, such as the performance of logistic regression and collaborative filtering models on different data sources to predict terms relevant to a set of advertiser seed terms. A third technique relies on advertiser bidding patterns, such as performing a singular value decomposition to a search term suggestion system in a pay-for-performance search market, such as including a positive and negative refinement method based on orthogonal subspace projections, using a small subset of bidded search terms.

Existing techniques for anticipating term relationships do not focus on bidder intentions and fail to take into account the large trove of existing data of the co-bidded terms. By not determining these relationships, existing technology overlooks additional functionality using co-bidded term and/or category information. The existing techniques perform processing operations on small scale data sets and fails to achieve results available from using second-order co-bidding information and being run on large data sets.

### SUMMARY OF THE INVENTION

The present invention provides a method and system for determining related bid terms. The method and system includes accessing a term database to determine a plurality of term pairs, the term pairs being paired terms bidded together in a term bidding operating environment. In the method and system, for each of the plurality of term pairs, the method and system includes determining similarity values for each of the term pairs. The method and system further includes generating a similarity matrix using the determined similarity values. And, the method and system includes generating an output result based on a co-bidded relationship between at least one of the terms and advertising information.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of a system for determining related bid terms in accordance with several embodiment of the present invention;

FIG. 2 illustrates a flowchart of the steps of one embodiment of a method for determining related bid terms in accordance with one embodiment of the present invention;

FIGS. 3-5 illustrate flowcharts of the steps of additional embodiments of the method of FIG. 2;

FIG. 6 illustrates a sample co-bidded term relational table in accordance with one embodiment of the present invention;

FIG. 7 illustrates a sample screen shot of a search term suggestion interface in accordance with one embodiment of the present invention; and

FIG. 8 illustrates a sample screen shot of search results page generated with advertisement placement in accordance with one embodiment of the present invention.

### DETAILED DESCRIPTION

In the following description, reference is made to the accompanying drawings that form a part hereof, and is shown by way of illustration specific embodiments in which the invention may be practiced. It is to be understood that other embodiments may be utilized and structural changes may be made without departing from the scope of the present invention.

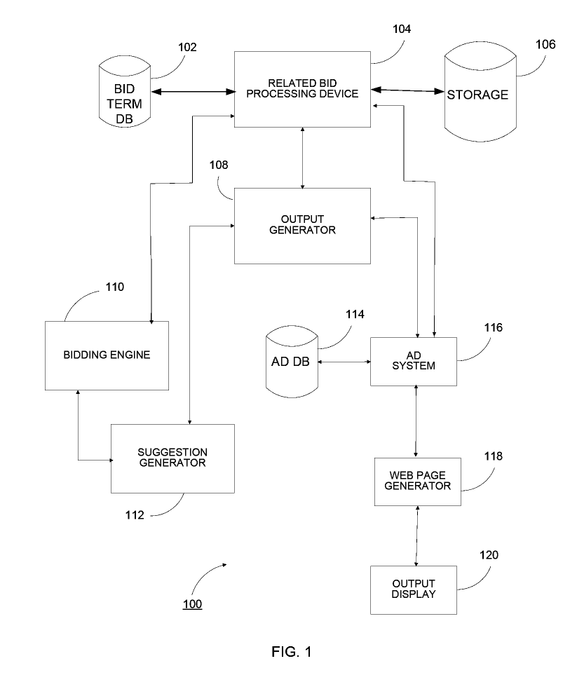

FIG. 1 illustrates a system 100 for determining related bid terms. The system 100 includes a bid term database 102, a related bid processing device 104 and a computer readable medium storage device 106. The system 100 further includes an output generator 108 and in various embodiments may include a bidding engine 110 and a suggestion generator 112, and/or may include an ad database 114, an advertisement system 116, a web page generator 118 and an output display 120.

The databases 102, 114 and computer readable medium 106 may be any suitable type of storage device capable of storing data thereon. The bid term database 102 may store bid terms, such as received from a bid system where various parties submit monetary bids on various terms (keywords) so that when a web page is generated, the winner bidder has the right to associate content (e.g. advertisement) on the web page. The computer readable medium 106 is operative to store executable instructions thereon. The ad database 114 may store advertisement information including ad content to be displayed on generated web content.

The processing device 104 may be any suitable type of processing device operative to perform processing operations in response to the executable instructions from the storage device 106, as recognized by one skilled in the art. It is recognized that the processing device 104 may be a local or remote processing device, as well as a single processing device or a distributed processing device across multiple processing platforms.

The output generator 108 may be a separate processing component or may be integrated within the processing device 104. The output generator 108 is illustrated in FIG. 1 as a stand alone separate processing component, but this is for illustration purposes only and not an express limitation of the system 100 because the processing aspects of the output generator 108 may be in response to executable instructions, such as instructions from the storage device 106.

The bidding engine 110 and suggestion generator 112 may be within the same processing environment as the processing device 104 and output generator 108, or may be in a separate processing environment in communication across a network. One example may be the bidding engine 110 and suggestion generator 112 being within a separate advertisement bidding exchange place on a separate web location and in communication with the processing device 104 and generator 108 via a web-based connection. Although, the bidding engine 110, while operating in accordance with known techniques, includes additional processing capabilities for related terms as described herein, such as performed by the suggestion generator 112.

The ad system 116 and web page generator 118, as well as the ad database 114, may also be within the same processing environment as the processing device 104 and output generator 108, or may be in a separate processing environment in communication across a network. The ad system 116 and web page generator 118 may operate in accordance with known techniques for selecting advertisements from the database 114 in response to one or more keywords and then generating web content including the advertisements in an output display 120. Although, the ad system 116, while operating in accordance with known techniques includes additional processing capabilities for related terms as described herein. The output display 120 may be a search engine search results page that includes search results as well as paid content. In another embodiment, the output display 120 may be a content-based display that includes advertisement associated therewith, such as the example of a news story. Where the present method and system can operate in a search engine environment, the processing operations described herein are equally applicable to any web-based content display and not restricted to search engine results.

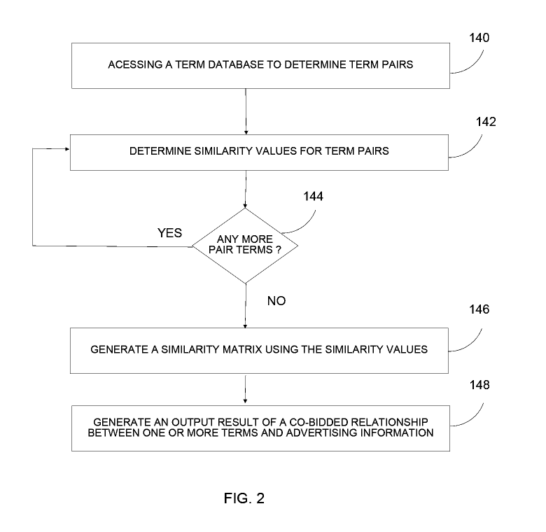

The operations of the system 100 are described in further detail below, including relative to the methodologies of the flowcharts of FIGS. 2-5. FIG. 2 illustrates a flowchart of the steps of one embodiment of a method for determining related bid terms. A first step, step 140, includes accessing a term database to determine term pairs. With reference to FIG. 1, this may include accessing the term database 102. The terms in the term database may be stored therein from any number of suitable sources, the terms stored with existing co-bidding information. As used herein, co-bidding information refers to information associating a first term with a second term as indicated by bidding or advertiser information, e.g. an advertiser may associate the two terms “MP3” and “iPod”®. It is via this term database and the co-bidded term information that the present system generates an intent driven model to approximate and anticipate user behavior.

A next step, step 142, is to determine similarity values for the term pairs. One embodiment for determining similarity values includes calculating a feature vector for each bidterm b. One embodiment includes generating pointwise mutual information feature vectors for each bidterm, b, where pmi_{b} is the pointwise mutual information between bidterm b and co-bidded term f according to Equation 1.

$${pmi}_{bf} = log \frac{\frac{{c}_{bf}}{N}}{\frac{{\sum }_{i = 1}^{n} {c}_{if}}{N} \times \frac{{\sum }_{j = 1}^{n} {c}_{bj}}{N}} \qquad Equation 1$$

In Equation 1, c_{bf} is the frequency of co-bidded term f occurring with bid term b, n is the number of unique bidterms and N is the total bidterm occurrences. It is appreciated that two bidterms that capture the same intents will have more similar feature vectors than two bidterms that capture different intents. Equation 2 defines similarity between two bidterms bᵢ and bⱼ using the cosine similarity metric between their PMI feature vectors, as used herein.

sim(bᵢ, bⱼ)=cosine(PMI(bᵢ), PMI(bⱼ)) Equation 2

For equation 2, this is where PMI(bₖ) is the feature vector of bid term bₖ consisting of, in this embodiment, PMI scored feature with bₖ. Other possible statistics include, but are not limited to, tf-idf, log likelihood and frequency. The feature vector, also referred to as a co-bid vector is used to determine the similarity values. The co-bid vector may be generated using the frequency data described above, as well as may be generated using importance measure, such as the statistics described above.

The similarity value is calculated for all term pairs, so in this embodiment, the next step, step 144, is a determination if there are any more pair terms. If yes, the method reverts to step 142 and continues to cycle until the answer to the inquiry of step 144 is negative. If no, the method proceeds to the next step, step 146, which is the generation of a similarity matrix using the similarity values.

It is recognized that the calculation of the similarity between all pairs of bidterms may be computationally intensive, but the present system and method may operate in a large scale environment accounting for a large scale number of bid terms and bid term relationships. Based on the large scale operations, one embodiment provides for the utilization of a generalized sparse-matrix multiplication approach based on the observation that a scalar product of two vectors depends only on the coordinates for which both vectors have non-zero values. Similarly, the features shared by both vectors can determine cosine similarity. Determining which vectors share a non-zero feature can be achieved by building an inverted index for the features, which can reduce computational costs. Therefore, the computation focuses on the user intent instead of the previous techniques described in the background of the invention.

The similarity matrix takes a keyword or category and returns one or more similar keywords or categories. In one embodiment, a clustering algorithm can be run on top of the similarity matrix to explore related or additional terms or categories. For example, the above described co-bid vector, also referred to as the feature vector, could be a co-category vector, thus determining similarity values between categories.

With respect to FIG. 1, the steps described above may be performed by the related bid processing device 104 in response to executable instructions from the computer readable medium 106.

In the method of FIG. 2, a next step, step 148, is the generation of an output result of a co-bidded relationship between one or more terms and advertising information. The generation of the result may be illustrated in various embodiments, whereby in general reference, the methodology of FIG. 2 allows for the determination of related bid terms and the step 148 allows for the generation of a resultant operation and transformation of the bid term data from the database 102 of FIG. 1 into a usable result.

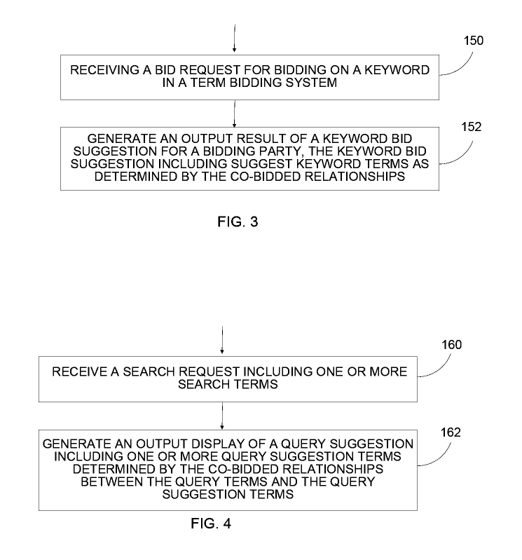

Various embodiments of the generation of the output results are described in further detail relative to the flowcharts of FIGS. 3-5. Each flowchart illustrates a different embodiment of a method for determining related bid terms, the embodiments differ based on the usage of the relationships between co-bidded terms, and as such the various outputs that can be generated.

The embodiment of FIG. 3 includes steps following in relation to the steps of FIG. 2. A first step, step 150, is receiving a bid request for bidding on a keyword or multiple keywords in a term bidding system. With reference to FIG. 1, this may include the receipt of a bid request in the bidding engine 110. For simplicity purposes, the general bidding engine 110 is shown, but it is recognized that the bidding engine in normal operations includes any number of users engaging the bidding engine and conducting online bidding operations for various keywords. Also, not expressly illustrated, but as recognized by one skilled in the art, the bidding engine 110 may also populate data to the bid term database 102.

When a bid request is received, this provides a bid term or a keyword that can be used as a reference point for utilizing the co-bidding relationship information. In the system 100, the related bid processing device 104 may receive the bid and reference the existing keyword information to determine all the similar terms, e.g. all the other terms of the term pairs including the keyword upon which the bid was placed.

From this, the output generator 108 may coordinate with the suggestion generator to generate an output usable by the bidding engine. In reference to FIG. 3, the next step, step 152, is to generate an output result of a keyword bid suggestion for a bidding party, the keyword bid suggestion including suggested keyword terms as determined by the co-bidded relationships.

In one example, when the bidding engine receives the suggestions, an output display may be provided of alternative keyword terms upon which the user may seek to place a bid. This information can be used to expand the scope of an advertisement campaign, or in another approach could offer an advertiser more cost-effective options, e.g. if the original term is more expensive, less expensive keyword terms may be suggested. Thereby, the present methodology may be utilized for improving the operations of a bidding engine, not only the effectiveness of the engine, but also the benefits to the bidding advertisers as well.

In another embodiment, FIG. 4 illustrates a flowchart of the steps relating to a search interface. The embodiment of FIG. 4 includes steps following in relation to the steps of FIG. 2. A first step, step 160, is to receive a search request including one or more search terms. In general terms, this may be recognized by the ad system 116 of FIG. 1, wherein the ad system is associated with a search engine or any other web location that includes a search interface (e.g. a search toolbar on a news content web location). For the sake of brevity, aspects of the ad system 116 have been omitted including users accessing a web location across a networked, e.g. Internet, connection in accordance with known techniques.

The search request includes search terms. The ad system 116 may then utilize these search terms as input to reference the similarity matrix to acquire similar keywords. In this embodiment, the similar keywords can then be presented to the user as alternative query suggestion terms. As such, in the flowchart of FIG. 4, the next step is to generate an output display of a query suggestion including one or more query suggestion terms determined by the co-bidded relationships between the query terms and the query suggestion terms. The output resultant display may be in accordance with known techniques for user suggestions, whereas the generation of those suggestion terms is based on the techniques described above accounting for co-bidding relationships between different terms.

This embodiment broadens not only the scope of a user search, but also generates a broadened back end advertisement environment by facilitating the usage of a broader scope of terms in searching operations. User suggestions allow users to select terms that they might not have originally entered, and as such without users entering the terms, they may not then be available to particular advertisements associated therewith. By increasing the usage of related terms in searching operations, the search engine and advertising system increases the breadth of terms used for advertising purposes.

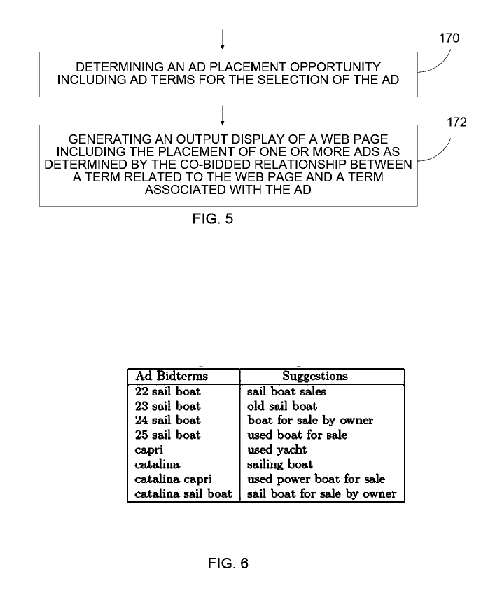

By that similar nature, FIG. 5 illustrates a flowchart of another embodiment relating to operations of the ad system 116. The embodiment of FIG. 5 includes steps following in relation to the steps of FIG. 2. A first step, step 170, is to determine an ad placement opportunity including ad terms for the selection of the advertisement. This may include the ad system 116 of FIG. 1 receiving the user search request with search terms, those search terms are keywords usable for determining which ads are placed on the resultant web page. As recognized by one skilled in the art, the ads that are to be placed may be selected based on the bidding operations of bidding engine 110.

Again, similar to the embodiments described above, the ad system 116 may reference the related bid processing device 104 and determine related bids based on the ad terms. Thereby, the next step, step 172, is to generate an output display of a web page including the placement of one or more ads as determined by the co-bidded relationship between a term related to the web page and a term associated with an ad.

With reference to FIG. 1, the web page generator 118 may generate a web page. Using the example of a search engine, the generated web page may include search result content and advertisements to be inserted therein. The generated web page is then provided to the output display 120, which as recognized by one skilled in the art could be on a user computer across a networked connection. Accordingly, the intent driven bidterm suggestion operations described herein can be equally applicable to the selected advertisement resultantly selected and displayed.

The embodiment of FIG. 3 provides for broadening the scope of terms or keywords upon which advertisers can place bids. The embodiment of FIG. 4 provides for broadening the scope of terms or keywords users can utilize when conducting interactive operations that would generate an advertising opportunity. The embodiment of FIG. 5 provides for broadening the scope of terms or keywords that can be used for the selection of advertisements to be placed on resultant web pages. The broadening of the scope of term or keywords is provided by the system 100 of FIG. 1 as well as by the methodology of the flowchart steps of FIG. 2.

It is further appreciated and within the scope of the present invention that wherever the present discussion herein relates to a term, it is also equally applicable to a category. The categorization may, in essence, be a larger genus-level classification of terms. For example, the present method and system could similarly match ads by an association with bid terms, keywords, as well as to categories. The category-level information can be equally usable for advertising matching as well category and subsequent term suggestions as denoted herein.

For example, on a category level, a user may conduct a search on a keyword “MP3 Player.” This keyword could be associated with the category of “music device.” The method and system can recognize a user intent and possible relationship, such as the relationship that people who buy music devices may also buy cameras. Thus, the system and method may include the insertion of a camera advertisement next to the search results for the search term MP3 player based on a category-level recognition.

For further illustration of the present method and system, FIG. 6 illustrates a sample table that may be generated using the intent driven bidterm suggestion technique described herein. In the sample table of FIG. 6, the first column lists sample bid terms, such as “22 sail boat,” “23 sail boat” etc. Using the techniques described herein, the related bid processing device 104 may compute similarity values for term pairs and generate the similarity matrix. From the similarity matrix, suggested related keyword or additional bid terms emerge, as noted on the right side column. These suggested terms are determined based on the mining of existing co-bid term data with calculations to estimate user intentions. The suggested terms of the right side column can then be used in any number of suitable embodiments, providing for broaden advertising and user-experience interactions.

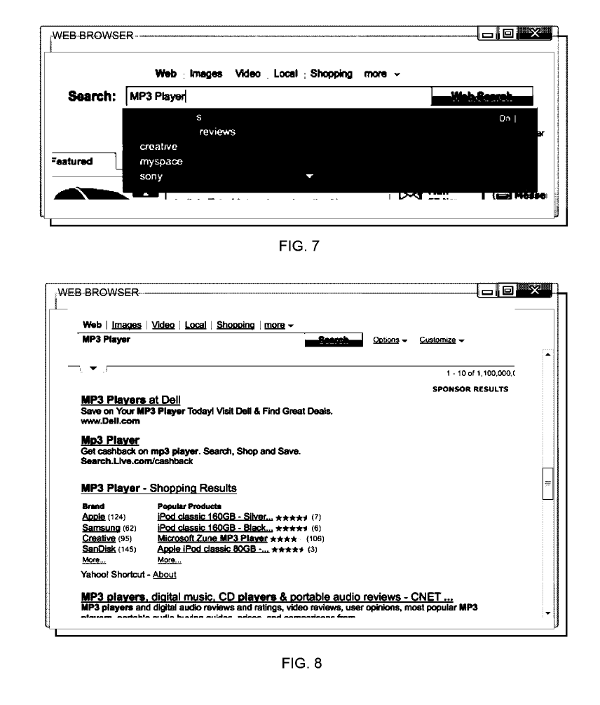

For further illustration for one operating environment of the present method and system, FIG. 7 illustrates a sample screen shot of a search term suggestion interface. In this sample interface, the user is entering the search term “MP3 Player” and the dynamic search suggestion interface provides a list of sample keywords to include in the search input bar. Although, for additional broadening of the term suggestions, the interface includes back-end processing as described herein. It is recognized that there are existing search term suggestion systems, but these suggestions suffer from the same problems with other term matching systems. While the interface suggestions may include terms similar or identical to terms from previous term suggestion operations, there also exists additional and broader suggestions for the user to enter for the searching operation.

For further illustration of another operation environment of the present method and system, FIG. 8 illustrates a sample screen shot of a search results page that includes ads inserted therein. As an exemplary continuation of FIG. 7, this may a sample search result based on a search conducted for the term “MP3 Player.” The selection of advertising in accordance with the present embodiment includes the back-end processing as described herein for ad selection. Therefore, the ad selection, shown here under the “sponsored results” identifier, may be selected based on co-bidded term associations from an intent-driven bid term suggestion analysis.

It is noted that in existing advertising systems and search engine technology, advertisers typically bid on a few common terms. The scarcity of data broadened out to additional terms makes prior ad matching techniques difficult. Suggesting additional bid terms can significantly improve ad clickability and conversion rates. The present method and system provides for a large scale bid term suggestion system that models an advertiser's intent and determines new bid terms consistent with that intent.

FIGS. 1 through 8 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

We claim:

1. A method for determining related bid terms, the method comprising:
accessing a term database to determine a plurality of term pairs, the term pairs being paired terms bidded together in term bidding operating environment;
for each of the plurality of term pairs, determining similarity values for each of the term pairs;
generating a similarity matrix using the determined similarity values; and
generating an output result based on a co-bidded relationship between at least one of the terms and advertising information.

2. The method of claim 1, wherein the advertising information includes keywords such that method further comprises:
generating an output result of a keyword bid suggestion for a bidding party, the keyword bid suggestion including suggested keyword terms as determined by the co-bidded relationships.

3. The method of claim 2, wherein the bidding party is one or more users placing a monetary bid on a plurality of bid terms relating to the placement of advertisements relative to a third party use of the bid terms.

4. The method of claim 1, wherein the advertisement information includes information for the placement of advertisements on a web page, the method further comprising:
generating an output display of the web page including the placement of one or more advertisements, the selection and placement of the one or more advertisements determined by the co-bidded relationship between a term related to the web page and a term associated with the one or more advertisements.

5. The method of claim 1 further comprising:
generating an output display of a query suggestion including one or more query suggestion terms determined by the co-bidded relationships between the query terms and the query suggestion terms for a user entering a search query request.

6. The method of claim 1 further comprising:
determining additional terms for the term pairs using a clustering algorithm relative to the similarity matrix.

7. The method of claim 1 further comprising:
generating a co-bid vector for the one or more of the bid terms to determine the similarity values.

8. The method of claim 7, wherein the co-bid vector is generated using at least one of: frequency data and an important measure.

9. The method of claim 1, wherein the bid term may include a term category.

10. The method of claim 9 further comprising:
generating a co-category vector for one or more of the bid terms to determine similarity values.

11. A system for determining related bid terms, the system comprising:
a computer readable medium having executable instructions stored thereon; and
a processing device, in communication with the computer readable medium, the processing device, in response to the executable instructions, operative to:
access a term database to determine a plurality of term pairs, the term pairs being paired terms bidded together in term bidding operating environment;
for each of the plurality of term pairs, determine similarity values for each of the term pairs;
generate a similarity matrix using the determined similarity values; and
generate an output result based on a co-bidded relationship between at least one of the terms and advertising information.

12. The system of claim 11, wherein the advertising information includes keywords such that processing device, in response to further executable instructions, is further operative to:
generate an output result of a keyword bid suggestion for a bidding party, the keyword bid suggestion including suggested keyword terms as determined by the co-bidded relationships.

13. The system of claim 12, wherein the bidding party is one or more users placing a monetary bid on a plurality of bid terms relating to the placement of advertisements relative to a third party use of the bid terms.

14. The system of claim 11, wherein the advertisement information includes information for the placement of advertisements on a web page such that processing device, in response to further executable instructions, is further operative to:
generate an output display of the web page including the placement of one or more advertisements, the selection and placement of the one or more advertisements determined by the co-bidded relationship between a term related to the web page and a term associated with the one or more advertisements.

15. The system of claim 11, wherein the processing device, in response to further executable instructions, is further operative to:
generate an output display of a query suggestion including one or more query suggestion terms determined by the co-bidded relationships between the query terms and the query suggestion terms for a user entering a search query request.

16. The system of claim 11, the processing device, in response to further executable instructions, is further operative to:
determine additional terms for the term pairs using a clustering algorithm relative to the similarity matrix.

17. The system of claim 11, the processing device, in response to further executable instructions, is further operative to:
generate a co-bid vector for the one or more of the bid terms to determine the similarity values.

18. The system of claim 17, wherein the co-bid vector is generated using at least one of: frequency data and an important measure.

19. The system of claim 11, wherein the bid term may include a term category.

20. The system of claim 19, the processing device, in response to further executable instructions, is further operative to:
generate a co-category vector for one or more of the bid terms to determine similarity values.
